(19) United States
(12) Patent Application Publication
(10) Pub. No.: US 2012/0164081 A1
(43) Pub. Date: Jun. 28, 2012

(54) NON-HAZARDOUS FOAMING ANT SPRAY BASED ON NATURAL OILS, CARBOXYLATE SALTS AND OPTIONAL SYNERGISTS

(75) Inventors: Frederique M. de Lame, Los Angeles, CA (US); James Crucitt, San Tan Valley, AZ (US); Richard Merwin, Phoenix, AZ (US); Mike Wong, Scottsdale, AZ (US)

(73) Assignee: The Dial Corporation, Scottsdale, AZ (US)

(21) Appl. No.: 13/412,191

(22) Filed: Mar. 5, 2012

Related U.S. Application Data
(62) Division of application No. 12/599,901, filed on Nov. 12, 2009, now abandoned.
(60) Provisional application No. 60/937,111, filed on Jun. 25, 2007.

(51) Int. Cl. A01N 25/16; A01P 7/04

(52) U.S. Cl. 424/45

(57) ABSTRACT

A foaming insecticidal ant spray is described that minimally comprises an essential oil, an emulsifier, a carboxylate salt and water, which has maximum mortality on ants. A method for killing and controlling ants is described wherein the composition is foamed directly onto the ants whereby the ants become entangled within the foam, increase their contact time with the compositions, and perish.

### CROSS-REFERENCE TO RELATED APPLICATIONS

This application is a division of U.S. application Ser. No. 12/599,901 filed Nov. 12, 2009, which was the U.S. National Stage of PCT Application Serial No. PCT/US2008/007781 filed on Jun. 23, 2008, which claims priority to U.S. Provisional Application No. 60/937,111 filed on Jun. 25, 2007.

### FIELD OF THE INVENTION

This invention generally relates to insecticide compositions and methods for their use, and more particularly to foaming liquid compositions comprising non-hazardous ingredients that are useful for the rapid kill and control of ants.

### BACKGROUND OF THE INVENTION

Ant species number in the tens of thousands and vary around the country and around the world, with new species being found continuously. Some ants that may require a control in numbers or in behavior include ants from the subfamily Dolichoderinae, including the genus Dorymyrmex, Forelius, Liometopum and Tapinoma, the subfamily Formicinae, including the genus Acanthomyops, Acropyga, Camponotus, Formica, Lasius, Myrmecocystus, Paratrechina and Polyergus, the subfamily Myrmicinae, including the genus Aphaenogaster, Crematogaster, Ephebomyrmex, Formicoxenus, Leptothorax, Manica, Messor, Monomorium, Myrmecina, Myrmica, Pheidole, Pogonomyrmex, Pyramica, Rogeria, Solenopsis, Stenamma, Strumigenys, and Trachmyrmex, the subfamily Ecitoninae including the genus Neivamyrmex, the subfamily Ponerinae including the genus Amblyopone, Hypoponera and Odontomachus, and the subfamily Pseudomyrmicinae including the genus Pseudomyrmex.

At the very least, many ant species pose a nuisance problem but some species can present significant destruction in the home, including damage to wooden structures, roofs, and electrical equipment. Ants have also been known to introduce contamination and disease by spreading pathogens and some common ant species inflict painful bites. In agriculture, some ants feed on germinating seeds and crop seedlings while some domesticate and protect other pest insects that feed on crops. Examples of pest ants include but are not limited to carpenter ants (Camponotus modoc), red carpenter ants (Camponotus ferrugineus Fabricius), black carpenter ants (Camponotus pennsylvanicus De Geer), Pharaoh ants (Monomorium pharaonis Linnaeus), little fire ants (Wasmannia auropunctata Roger), fire ants (Solenopsis geminata Fabricius), red imported fire ants (Solenopsis invicta Buren), black imported fire ants (Solenopsis richteri), southern fire ants (Solenopsis xyloni), Argentine ants (Iridomyrmex humilis Mayr), crazy ants (Paratrechina longicornis Latreire), pavement ants (Tetramorium caespitum Linnaeus), cornfield ants (Lasius alienus Foerster), the odorous house ant (Tapinoma sessile Say), little black ants (Honomorium minimum), and ghost ants (Tapinoma melanocephalum).

Non-hazardous pest control products are well known in the prior art and are found in both the retail and commercial insecticide markets. It was recognized some time ago that certain natural oils, particularly tree and plant extracts, could be used to control insects in much the same way that the tree or plant provides for its own natural insect defenses. To prepare non-hazardous insect control products, researchers have typically looked to combinations of EPA exempted products and inert ingredients permitted under FIFRA to find synergies that give the desired insect control. However, much of the past work was consumed with emulsifying various combinations of oils into water using the only two emulsifiers on the lists of FIFRA exempted or inert materials, namely sodium lauryl sulfate or lecithin, without much regard to pH/salt effects or the possible effect of other “synergists” besides the emulsifier itself. Additionally the prior art in natural insecticides is devoid of mention that foam may assist in the efficacy of non-hazardous insecticides. The prior art is really proliferated with patents claiming complex combinations of essential oils emulsified into water with either or both of the above-mentioned emulsifiers, with the results being weakly effective products that for the most part are better insect repellants than products useful for “knockdown” or “kill” of insects. For example, U.S. Patent Application 2002/0034556 by inventor Khazan describes insect repellant compositions with complex combinations of essential oils.

The need for extensive combinations of various essential oils for efficacy (even just for insect repellency) is exemplified by several patent citations from the prior art. Aside from Khazan mentioned above, U.S. Pat. No. 5,693,344 issued to EcoSmart claims an insecticide comprising a carrier and a “neurally effective fragrance”, wherein the neurally effective fragrance is a chemical selected from the group consisting of amyl cinnamic aldehyde, amyl salicylate, anisic aldehyde, benzyl acetate, cinnamic alcohol, diethyl phthalate, dipropylene glycol, ionone, methyl anthranilate, methyl ionone, phenyl ethyl alcohol, terpinyl acetate, 4-tert butylcyclohexyl acetate, terpineol and mixtures thereof.

U.S. Pat. No. 6,004,569 issued to EcoSmart claims a method for killing or affecting the feeding habits of invertebrates by applying a composition comprised of an affector agent having a six-member carbon ring with at least one oxygenated functional group and completely devoid of nitrogen. Such 6-membered ring oxygenated actives include anethole, benzyl acetate, benzyl alcohol, carvacrol, cinnamic alcohol, eugenol, phenyl ethyl alcohol, pulegone, terpineol, and mixtures thereof. Although there are no emulsifiers in the claims, the patent describes many useful emulsifiers including sorbitan monooleates, ethoxylated castor oils, LAS, sulfosuccinates, etc., all of which fall outside EPA exemption. These compositions are targeted to invertebrates (especially insects), arachnids and larvae.

U.S. Pat. No. 6,130,253 issued to XiMed claims a complex composition comprising redistilled limonene, ionone, linalool, geraniol, eugenol, along with one terpene selected from carvone and myrcene. The claimed compositions are targeted at “terrestrial arthropods” including lice, mites, ticks and ants.

Lastly, U.S. Pat. No. 6,183,767 issued to EcoSmart claims compositions for killing cockroaches, armyworms, fire ants and spider mites comprising a blend of cinnamic alcohol, eugenol and α-terpineol, a blend of benzyl acetate, benzyl alcohol, phenyl ethyl alcohol, eugenol and α-terpineol, or a blend of benzyl acetate, benzyl alcohol, phenyl ethyl alcohol, cinnamic alcohol and α-terpineol.

What is clearly evident from the prior art is that the past approach to formulating non-hazardous insecticides has been to simply emulsify complex mixtures, or “cocktails”, of essential oils into water, in seemingly random fashion for a “broad spectrum approach” to pest control. Some of the confusion in the prior art certainly comes from the fact that essential oil extracts are in themselves complex mixtures of organic molecules, and some prior art refers to these individual molecules and some art to the more complex extract mixtures. Seeing that most essential oils are quite expensive, such a shotgun approach makes little sense, especially if targeting a single pest such as ants or roaches. What is thus lacking in the prior art are non-hazardous pesticides formulated around single essential oils, where the efficacy is heightened through the optimization of the co-ingredients and/or the physical delivery of the solution.

### SUMMARY OF THE INVENTION

Rather than proliferate the endless combinations of oils in search of non-hazardous insecticides, the present invention shows that salt effects can be brought to bear on the problem of creating more effective, non-hazardous insecticides that comprise but a few ingredients. To that end, a particular synergistic formula has been discovered that unexpectedly provides rapid mortality to ants and good control of ant behavior without venturing outside the FIFRA exempted and inert ingredient lists and without the added complexity and cost of using several or more essential oils in combination. The present invention takes advantage of a previous unknown increase in efficacy available by formulating natural oil emulsions further including overlooked electrolytes such as carboxylate salts. Through judicial choice of carboxylate salts, formulas typically useful only for repellency become lethal to ants. Additionally this invention shows that delivery method (i.e., foaming) heightens the efficacy of the natural extract mixture against ant pests.

That being said, the present invention shows that single natural extracts such as geranium oil, thyme oil, rosemary oil, and the like, emulsified into water preferably with an EPA exempt emulsifier, can be fatal to ants provided that previously untaught salts are added. Additionally the delivery of the present compositions in a way to create foam increases the lethal effect to ants. The present invention also describes optional synergists, such as phenyl ethyl propionate, to boost efficacy while reducing the amount of the expensive natural extracts in the formula.

The present invention is a foaming liquid that kills, repels and controls ants, preferably comprised of EPA exempted products and permissible inert ingredients under FIFRA. The compositions are purposely kept simple for the sake of easing manufacturing burden and controlling costs, and are compositions that rely on the heightened efficacy of a single natural extract through judicious selection of both the co-ingredients and the method of application to the ants.

More specifically the present invention is a liquid insecticide for ants that minimally comprise a natural plant or tree extract (e.g. geranium oil, thyme oil, etc.), an emulsifier, a carboxylate salt, and water. A non-limiting embodiment of the present invention is a liquid insecticide comprising rose geranium oil, sodium lauryl sulfate as the emulsifier, monosodium citrate as the carboxylate salt, and water, along with optional dyes and other adjuvant. A second non-limiting embodiment comprises reduced geranium oil levels and the added synergist 2-phenyl ethyl propionate.

### DETAILED DESCRIPTION OF THE INVENTION

The following description is of exemplary embodiments only and is not intended to limit the scope, applicability or configuration of the invention in any way. Rather, the following description provides a convenient illustration for implementing exemplary embodiments of the invention. Various changes to the described embodiments may be made, for example in the function and arrangement of the ingredients and elements described without departing from the scope of the invention as set forth in the appended claims. Additionally, though described herein in general terms of a liquid insecticide that may be foamed through use of a non-aerosol foaming trigger sprayer or by means of an aerosolized delivery, other forms of the insecticide are contemplated, for example, pastes, powders or volatilized vapors that may be applied as appropriate to the product form. Although the preferred embodiments stay within the EPA/FIFRA tables of exempted products and allowable inert ingredients, other emollients, electrolytes, solvents, etc. and the like that may come into the exempt and inert ingredient lists in the future are contemplated, and use of alternative co-ingredients currently not on these exempted and inert lists do not deviate from the spirit of the present invention and may find use in the present invention. Additionally, although described in terms of a foaming spray to control ants, it is expected that the compositions of the present invention will show at least repellency or even mortality against a variety of crawling arthropods including roaches. Lastly, the liquid compositions of the present invention may be distributed directly onto ants, their mounds or their trails in a variety of methods, for example by pouring, spraying, foaming, pumping of liquid or vapors through pipes, etc., using hand held bottles, hand-pumped sprayers or motorized industrial sprayers, all of which are within the scope of the present invention.

That being said, the present invention is a liquid insecticide effective against ants that is comprised of an essential oil emulsified into water to form a stable micro-emulsion, along with an added carboxylate salt. Very briefly, in the absence of emulsifiers, the water and essential oil will, when mixed in appropriate proportions, form either a micellar solution or an oil-in-water emulsion. With the appropriate emulsifier(s) added, the interfacial tension at the interface between the emulsion droplets and the aqueous phase may be reduced to a very low value. This reduction of the interfacial tension results in spontaneous break-up of the emulsion droplets into consecutively smaller and smaller aggregates until the state of a transparent colloidal sized emulsion, that is a “micro-emulsion”, is reached. In a micro-emulsion, thermodynamic factors come into balance with varying degrees of stability related to the total free energy of the micro-emulsion. Some of the thermodynamic factors involved in determining the total free energy of the system are (1) particle-particle potential; (2) interfacial tension or free energy (stretching and bending); (3) droplet dispersion entropy; and (4) chemical potential changes upon formation. A thermodynamically stable system is achieved when interfacial tension or free energy is minimized and droplet dispersion entropy is maximized. Thus, the role of emulsifiers in the formation of a stable oil-in-water (o/w) micro-emulsion is to decrease interfacial tension to modify the micro-emulsion structure and increase the number of possible configurations. Generally, an increase in emulsifier concentration results in a wider temperature stability for the liquid (i.e., outside of which the mixture may become cloudy). In simpler terms, a stable micro-emulsion refers to a “thermodynamically stable oil-in-water emulsion” where the oil droplets are so small that light is not refracted and the mixture appears clear. The formation of a stable aqueous micro-emulsion from an essential oil requires the proper selection of emulsifiers, possibly supplemented with other stabilizers such as co-emulsifiers and/or various solvents. Stable micro-emulsions in the art of aqueous fragrance oil emulsions are described in U.S. Pat. Nos. 5,374,614, 6,448,219 and 6,960,625, and are incorporated in their entirety herein. Below is described some of the preferred emulsifiers, stabilizers and solvents that may be used to achieve a stable micro-emulsion for use in the present invention. The present invention may require the use of a mixture of several different emulsifiers and solvents, along with the oil and water, to achieve a stable micro-emulsion. However, depending on the nature of the essential oil and the level to be incorporated, it may be possible to achieve a stable micro-emulsion by simply using one emulsifier, or simply one emulsifier and one solvent to emulsify the oil into the water. Other essential oils may require tricky combinations of several emulsifiers and solvents to achieve stable, clear micro-emulsions, and this is anticipated when varying the sources of a particular essential oil, for example by changing the species of a particular plant genus or moving to an alternative supplier that uses a different purification protocol. Stable micro-emulsions are achievable by judicious choice of emulsifiers that include, but are not limited to, anionic, nonionic or zwitterionic, and cationic materials and/or solvents, and combinations of these materials as necessary for the particular essential oil to be emulsified at the desired efficacious level.

Additionally, for the purpose of optimizing ant mortality efficacy, an electrolyte is added that is preferably a carboxylate salt, herein referred to generally as a “carboxylate”. Thus, the present invention is generally described as minimally comprising essential oil, at least one emulsifier, at least one carboxylate salt, and water, along with additional surfactants, co-emulsifiers and/or solvents to assist with micro-emulsion stability, other preservatives, electrolytes, dyes and fragrances and other adjuvant. The additional surfactants may find use in the present compositions to boost foaming or to aid formation of a more stable and substantive foam, much like the well-known combinations of surfactants used in foaming products ranging from hand dishwashing liquids to agricultural crop markers that require high foam heights and suds stability.

The Essential Oil

The “essential oil” for incorporation into the compositions of the present invention refers to either naturally or synthetically derived natural products or mixtures thereof. Herein, “essential oil” is intended to include a broader class of natural products comprising natural oils extracted from plants and trees and their fruits, nuts and seeds, (for example by steam or liquid extraction of ground-up plant/tree material), natural products that may be purified by distillation, (i.e., purified single organic molecules or close boiling point “cuts” of organic materials such as terpenes and the like), and synthetic organic materials that are the synthetic versions of naturally occurring materials (e.g., either identical to the natural material, or the optical isomer, or the racemic mixture). An example of the latter is D,L-limonene that is synthetically prepared and is a good and eco-friendly substitute for natural orange oil (mostly D-limonene) when crop yields are expensive due to citrus crop freezes. An example of a pure natural material within an extract is methyl isoeugenol, which is an important component of citronella oil. It's important to note that some naturally derived extracts may become prohibitively expensive, for example because of crop freezes, floods, drought or other calamities, and the synthetic equivalents of the mixture, or the synthetic equivalents of selected components of the mixtures, may become more useful than the actual naturally extracted essential oil mixture.

That being said, suitable essential oils for use in the present insecticidal spray are selected from the group consisting of: Absinth Oil, Almond Oil, Ambrette Seed Oil, Amyris Oil, Angelica Root Oil, Anethole 20/21 natural, Angelica Seed Oil, Aniseed Oil China star, Anise Star Oil, Balsam Fir Oil, Balsam Oil, Basil Oil, Bay Oil, Bergamot Oil, Birch Sweet Oil, Birch Tar Oil, Bitter Almond Oil, Bitter Orange Oil Cold Pressed, Black Pepper Oil Black Pepper Oleoresin 40/20, Bois de Rose, Buchu Oil, Cabreuva Oil, Cade Oil, Cajeput Oil, Calamus Oil, Camphor Oil White, Cananga Oil, Capsicum Oil, Caraway Seed Oil, Cardamom Seed Oil, Carrot Seed Oil, Cassia Oil, Cedarleaf Oil, Cedarwood Oil, Celery Leaf Oil, Celery Seed Oil, Chamomile Flower Oil, Chenopodium Oil (Wormseed), Cinnamon Bark Oil, Cinnamon Leaf Oil, Cistus Oil, Citronella Oil, Citronellol Terpenes, Clary Sage Oil, Clove Bud Oil, Clove Leaf Oil, Clove Stem Oil, Cognac Oil Green, Cognac Oil White, Copaiba Oil, Coriander Leaf Oil, Coriander Seed Oil, Cornmint Oil (Mentha Arvensis), Cumin Seed Oil, Cyclamen Oil, Cypress Oil, Davana Oil, Dill Herb Oil, Erigeron Oil, Estragon Oil (Tarragon Oil), Eucalyptus Oil, Fennel Oil Bitter, Fennel Oil Sweet, Fir Needle Oil, Galbanum Oil, Garlic Oil, Geranium Oil, Ginger Oil, Grapefruit Oil 10-Fold, Grapefruit Oil 5-Fold, Grapefruit Oil Cold Pressed, Grapefruit Oil Terpenes, Guaiac Wood Oil, Gurjun Balsam, Hemlock Oil (Spruce), Ho Leaf Oil, Ho Wood Oil, Hyssop Oil, Jasmin Oil, Juniper Berry Oil, Laurel Leaf Oil, Lavandin Oil, Lavender Oil, Lavender Spike Oil, Lemon Oil 10-Fold, Lemon Oil 5-Fold, Lemon Oil Cold Pressed, Lemon Oil Distilled, Lemon Oil Terpenes, Lemon Oil Washed, Lemongrass Oil, Lemongrass Oil Terpeneless, Lime Oil 5-Fold, Lime Oil Distilled, Lime Oil Terpenes, Lime Oil Washed, Litsea Cubeba Berry Oil, Mace Oil, Mandarin Oil Cold Pressed, Marjoram Oil Sweet, Musk Oil, Myrtel Oil, Neroli Oil, Nutmeg Oil, Ocotea Cymbarum Oil, Onion Oil, Orange Oil Bitter Cold Pressed, Orange Oil 10-Fold, Orange Oil 20-Fold, Orange Oil 5-Fold, Orange Oil Bitter 5-Fold, Orange Oil Cold Pressed, Orange Oil Terpeneless, Oregano Oil, Origanum Oil, Palmarosa Oil, Parsley Leaf Oil, Parsley Seed Oil, Patchouli Oil, Pennroyal Oil, Pepper Oil Black, Peppermint Oil (Arvensis), Petitgrain Oil, Pimenta Berry Oil, Pimenta Leaf Oil, Pine Needle Oil, Pine Oil Scotch, Pine Oil White, Rosalin Oil, Rose Oil, Rosemary Oil, Sage Clary Oil, Sage Oil, Sandalwood Oil, Sassafras Oil, Savory Oil, Spearmint Oil, Spike Lavender Oil (Lavender Spike), Spruce Oil (Hemlock), Star Anise Oil, Styrax Oil, Tagetes Oil, Tangelo Oil, Tangerine Oil, Tangerine Oil 5-Fold, Tangerine Oil Terpenes, Tarragon Oil (Estragon Oil), Tea Tree Oil, Thyme Oil, Thyme Oil White, Tumeric Oil, Purpentine Oil, Valerian Oil, Vanilla beans abs., Vetiver Oil, Wintergreen Oil (Methyl Salicylate Natural), Wormseed Oil, Wormwood Oil, and Ylang Ylang Oil.

Individual organic materials, (purified from the natural mixtures, or created through organic synthesis), that may substitute for, or may be added to, naturally extracted mixtures, may include; Allocimene, Benzaldehyde, Camphene, Alpha-Campholenic aldehyde, Camphor, L-Carvone, Cineoles, Cinnamic aldehyde, Citral, Citronellal, Alpha-Citronellol, Citronellyl Acetate, Citronellyl Nitrile, Coumarin, Para-Cymene, Dihydroanethole, Dihydrocarveol, d-Dihydrocarvone, Dihydrolinalool, Dihydromyrcene, Dihydromyrcenol, Dihydromyrcenyl Acetate, Dihydroterpineol, Dimethyloctanal, Dimethyloctanol, Dimethyloctanyl Acetate, Estragole, Ethyl-2 Methylbutyrate, Ethyl Vanillin, Eucalyptol, Eugenol, Fenchol, Geraniol, Geranyl Acetate, Geranyl Nitrile, trans-2-Hexenal, trans-2-Hexenol, cis-3-Hexenyl Isovalerate, cis-3-Hexanyl-2-methylbutyrate, Hexyl Isovalerate, Hexyl-2-methylbutyrate, Hydroxycitronellal, lonone, Isobornyl acetate, Isobornyl methylether, Iso-logifolene, Linalool, Linalool Oxide, Linalyl Acetate, Logifolene, Menthane Hydroperoxide, Menthol, Methone, L-Methyl Acetate, Methyl cedryl ketone, Methyl chavicol, Methyl Hexyl Ether, Methyl iso-Eugenol, Methyl-2-methylbutyrate, 2-Methylbutyl Isovalerate, Methyl salicylate, Musk ketone, Musk xylol, Myrcene, Nerol, Neryl Acetate, 3-Octanol, 3-Octyl Acetate, Phenyl ethyl alcohol, Phenyl Ethyl-2-methylbutyrate, cis-Pinane, Pinane hydroperoxide, Pinanol, Pine Ester, alpha-Pinene, beta-Pinene, alpha-Pinene Oxide, Plinol, Plinyl Acetate, Pseudo lonone, Rhodinol, Rhodinyl Acetate, alpha-Terpinene, gamma-Terpinene, Terpinene-4-OL, Terpineol, Terpinolene, Terpinyl Acetate, Tetrahydrolinalool, Tetrahydrolinalyl Acetate, Tetrahydromyrcenol, and vanillin.

Not being limited to any particular essential oil or purified/synthetic material having insect behavior-modifying efficacy, repellency or insecticidal efficacy, the preferred substances or essential oils for use in the present invention include geranium oil, thyme oil, cinnamon oil, citronella oil, clove oil, and eugenol.

Geranium Oil

Geranium oil is used extensively in the fragrance industry, as an insect repellent, and for other related purposes. For example, U.S. Pat. No. 4,940,583 issued to Thompson describes the use of geranium oil in an animal repellent composition. U.S. Pat. No. 4,923,685 to Forg et al. describes the use of geranium oil in a mouthwash. U.S. Pat. No. 4,579,677 to Hooper et al. claims the use of geranium oil as a fragrance for bleach. U.S. Pat. No. 4,311,617 to Ansari et al. describes the use of geranium oil in perfumery compositions.

Geranium oil is derived from plants of the genus Pelarconium and the family Geraniaceae. Some of the more major constituents of most geranium oils include geraniol (which is trans-3,7-dimethyl-2,6-octadien-1-ol) and citronellol (which is 3,7-dimethyl-6-octen-1-ol). Minor constituents include geranial (3,7-dimethyl-2,6-octadienol), citronellal (3,7-dimethyl-6-octenal), linalool (2,6-dimethyl-2,7-octadiene-6-ol), pelargonic acid (nonanoic acid and rhodinol (3,7-dimethyl-7-octen-1-ol). A variety of species of geranium plants exist throughout the world, with most having similar organic chemical constituents in the extracted oil. However, one species that grows almost uniquely in the Reunion Islands, Pelargonium graveolens, has a unique chemical composition. The geranium oil that may be used as the active ingredient in the ant spray of the present invention may be derived from any of the known geranium species. However, the more preferred geranium oil for use in the present ant spray is Rose Geranium Oil and is extracted from the species Pelargonium graveolans. This particular species of the geranium plant grows specifically in the Reunion Islands, but is now also found in some other locales such as Europe. Not only may oil extracted from other species of geranium plants be used in the compositions of the present invention, the combination of particular geranium oils may be desirable. The use of a natural extract is of course preferred over use of individual purified naturally occurring organic materials, such as a terpene, because it is not only less expensive not to use individual organic species, it is more natural and wastes fewer resources not to distill out and purify separate materials, and the natural oil may be more efficacious.

The geranium oil suitable for use in the present ant spray may be derived from Pelargonium graveolans or any of the other known plants according to any of the techniques in the art. For example, the oil may be extracted by steam distillation of the fresh plants harvested at the period of initial bloom. The oil is also commercially readily available from many essential oil suppliers, where the sources may be as widespread as Africa, Egypt, Europe or America.

The Rose Geranium Oil for use in the present ant spray, the oil extracted from the plant Pelargonium graveolens, has a rosier smell than that of its cousin Pelargonium odorantissimum, which is the more commonly known geranium essential oil and has a wilder “lemon-apple” smell. If the oil is made from the leaves when they start turning yellow it has a stronger rose aroma then the younger, greener leaves. Some imitation rose geranium oil is made from the cheaper P. odorantissimum oil that upon distillation can produce mock rose geranium oil. The most preferred oil for use in the ant spray of the present invention is the genuine essential oil of Pelargonium graveolens.

As mentioned above, geranium oil is comprised of a complex mixture of organic materials. Some of the organic species found in the oil readily available through steam extraction of the any of the geranium plants include phellandrene, copaene, cadinenes, bourbonenes, guaiazulene alcohols, phenylethylic alcohol, linalool, terpineol, citronellol, geraniol, nerol citronellyl formiate, geranyl, linalyl formiates, citronellyl andgeranyl acetates, citronellyl and geranyl butyrates, menthone, methylheptenone, isomenthone, 1,8-cineole, cis- and trans-rose oxide, neral, geranial, and citronellal. Rose Geranium Oil is comprised of various chemical constituents including α-pinene, myrcene, limonene, menthone, linalool, geranyl acetate, citronellol, geraniol and geranyl butyrate.

One or more of the oils extracted from the various species of plants or trees alluded to above may be emulsified into the insecticide compositions of the present invention at a level of from about 0.01% to about 10% by weight of the total composition. More preferred is from about 0.05% to about 5% and most preferred is from about 0.1% to about 3%.

The Emulsifier

The emulsifier for use in the insecticide compositions of the present invention may include various anionic, nonionic/zwitterionic or cationic materials, (e.g. surfactants), in any combination necessary to emulsify the preferred oils into a stable o/w micro-emulsion. For example, an anionic material for use in emulsifying oil into water includes anionic surfactants such as sulfates and sulfonates. Most preferred anionic surfactants include the alkyl sulfates, also known as alcohol sulfates. These surfactants have the general formula R—O—SO₃Na where R is from about 10 to 18 carbon atoms, and these materials may also be denoted as sulfuric monoesters of C₁₀-C₁₈ alcohols, examples being sodium decyl sulfate, sodium palmityl alkyl sulfate, sodium myristyl alkyl sulfate, sodium dodecyl sulfate, sodium tallow alkyl sulfate, sodium coconut alkyl sulfate, and mixtures of these surfactants, or of C₁₀-C₂₀ oxo alcohols, and those monoesters of secondary alcohols of this chain length. Also useful are the alk(en)yl sulfates of said chain length which contain a synthetic straight-chain alkyl radical prepared on a petro-chemical basis, these sulfates possessing degradation properties similar to those of the corresponding compounds based on fatty-chemical raw materials. From an emulsification standpoint and for stability of a resulting micro-emulsion, C₁₂-C₁₆-alkyl sulfates and C₁₂-Cᵢₛ-alkyl sulfates, and also C₁₄-C₁₅ alkyl sulfates, are preferred. In addition, 2,3-alkyl sulfates, which may for example be obtained as commercial products from Shell Oil Company under the brand name DAN®, are suitable anionic surfactants. Most preferred is to use powdered or diluted liquid sodium lauryl sulfate from the Stepan Company, recognized under the trade name of Polystep®. As mentioned earlier, sodium lauryl sulfate is presently found on the EPA exempted products list under FIFRA, and is therefore quite preferred. The preferred level of alcohol sulfate in the present invention is from about 0.1% to about 20%. Most preferred is from about 1% to about 10% as determined on an actives basis.

Also with respect to the anionic surfactants useful in emulsifying the preferred geranium, thyme, clove, citronella, or cinnamon oil, or other oils into water, the alkyl ether sulfates, also known as alcohol ether sulfates, are preferred. Alcohol ether sulfates are the sulfuric monoesters of the straight chain or branched alcohol ethoxylates and have the general formula R—(CH₂CH₂O)ₓ—SO₃M, where R—(CH₂CH₂O)ₓ— preferably comprises C₇-C₂₁ alcohol ethoxylated with from about 0.5 to about 16 mol of ethylene oxide (x=0.5 to 16 EO), such as C₁₂-C₁₈ alcohols containing from 0.5 to 16 EO, and where M is alkali metal or ammonium, alkyl ammonium or alkanol ammonium counterion. Preferred alkyl ether sulfates for use in one embodiment of the present invention are C₈-C₁₈ alcohol ether sulfates with a degree of ethoxylation of from about 0.5 to about 16 ethylene oxide moieties and most preferred are the C₁₂-C₁₅ alcohol ether sulfates with ethoxylation from about 4 to about 12 ethylene oxide moieties. It is understood that when referring to alkyl ether sulfates, these substances are already salts (hence “sulfate”), and most preferred and most readily available are the sodium alkyl ether sulfates (also referred to as NaAES). Commercially available alkyl ether sulfates include the CALFOAM® alcohol ether sulfates from Pilot Chemical, the EMAL®, LEVENOL® and LATEMAL® products from Kao Corporation, and the POLYSTEP® products from Stepan, however most of these have fairly low EO content (e.g., average 3 or 4-EO). Alternatively the alkyl ether sulfates for use in the present invention may be prepared by sulfonation of alcohol ethoxylates (i.e., nonionic surfactants) if the commercial alkyl ether sulfate with the desired chain lengths and EO content are not easily found, but perhaps where the nonionic alcohol ethoxylate starting material may be. The preferred level of C₁₂-C₁₈/0.5-9EO alkyl ether sulfate in the present invention is from about 0.1% to about 20%. Most preferred is from about 1% to about 10% on an actives basis.

Other surfactants that may find use as the emulsifier in the present compositions include sulfonate types such as the C₉₋₁₃ alkylbenzenesulfonates, olefinsulfonates, i.e. mixtures of alkenesulfonates and hydroxyalkanesulfonates and also disulfonates, as are obtained, for example, from C₁₂₋₁₈-monoolefins having a terminal or internal double bond by sulfonating with gaseous sulfur trioxide followed by alkaline or acidic hydrolysis of the sulfonation products. Sulfonates that may find use in the insecticide compositions of the present invention include the alkyl benzene sulfonate salts. Suitable alkyl benzene sulfonates include the sodium, potassium, ammonium, lower alkyl ammonium and lower alkanol ammonium salts of straight or branched-chain alkyl benzene sulfonic acids. Alkyl benzene sulfonic acids useful as precursors for these surfactants include decyl benzene sulfonic acid, undecyl benzene sulfonic acid, dodecyl benzene sulfonic acid, tridecyl benzene sulfonic acid, tetrapropylene benzene sulfonic acid and mixtures thereof. Preferred sulfonic acids, functioning as precursors to the alkyl benzene sulfonates useful for compositions herein, are those in which the alkyl chain is linear and averages about 8 to 16 carbon atoms (C₈-C₁₆) in length. Examples of commercially available alkyl benzene sulfonic acids useful in the present invention include Calsoft® LAS-99, Calsoft®LPS-99 or Calsoft®TSA-99 marketed by the Pilot Chemical Company. Most preferred for use in the present invention is sodium dodecylbenzene sulfonate, available commercially as the sodium salt of the sulfonic acid, for example Calsoft® F-90, Calsoft® P-85, Calsoft® L-60, Calsoft® L-50, or Calsoft® L-40. Also of use in the present invention are the ammonium salts, lower alkyl ammonium salts and the lower alkanol ammonium salts of linear alkyl benzene sulfonic acid, such as triethanol ammonium linear alkyl benzene sulfonate including Calsoft® T-60 marketed by the Pilot Chemical Company. The preferred level of sulfonate surfactant in the present invention is from about 0.1% to about 20%. Most preferred is to use sodium dodecylbenzene sulfonate at a level of from about 1% to about 10% by weigh on an actives basis to the total composition.

Additional anionic materials that may be necessary to form a stable essential oil-in-water micro-emulsion include the salts of alkylsulfosuccinic acid, which are also referred to as sulfosuccinates or as sulfosuccinic esters and which constitute the monoesters and/or diesters of sulfosuccinic acid with alcohols, preferably fatty alcohols and especially ethoxylated fatty alcohols. Preferred sulfosuccinates comprise C₈₋₁₈ fatty alcohol radicals or mixtures thereof. Especially preferred sulfosuccinates contain a fatty alcohol radical derived from ethoxylated fatty alcohols which themselves represent nonionic surfactants. Particularly preferred are sulfosuccinates whose fatty alcohol radicals are derived from ethoxylated fatty alcohols having a narrowed homolog distribution. The anionic sulfosuccinate surfactant may be present in the composition in a range from about 0.1% to about 20% by weight of the composition, more preferably 1% to 10% by weight of composition.

The emulsifier for use in the present invention may also include at least one nonionic material, for example, nonionic surfactants, polyalkylene glycols, fatty alcohols, or other nonionic stabilizers, or mixtures thereof. Preferred nonionic surfactants include ethoxylated, propoxylated, or mixed ethoxylated/propoxylated; alkylphenol ethers, linear aliphatic or fatty alcohols C₄-C₁₆, mono- and di-esters of aliphatic C₄-C₁₆ carboxylic acids, branched aliphatic alcohols with a main aliphatic carbon chains of C₄-C₁₆, hydrogenated castor oils (such as the Cremophor® materials from BASF) and glycols; and ethoxylated hydrogenated castor oil monopyroglutamic monoisostearic diesters, ethoxylated glycerol monopyroglutamic moniostearic diesters, and other pyrrolidon carboxylic acid derivatives. A preferred ethoxylated aliphatic alcohol for use in the present invention is Tomadol® 25-12, from Tomah, which is essentially C₁₂-C₁₅ alcohol with an average 12 moles ethylene oxide. Also preferred is Eumulgin® HPS from Cognis, which is a mixture of ethoxylated alcohols, EO/PO glycol ethers, and ethoxylated hydrogenated castor oil. Other nonionic materials that find use in the present invention include polyalkylene glycols, such as polyethylene glycols or PEG's, most particularly PEG-3 up to PEG-100, the Span®, Brij® and Tween® products from Uniqema, and Genapol® products from Clariant. Other preferred nonionic surfactants include the amine oxide surfactants. The preferred amine oxide surfactant for use in the present invention is typically a trialkyl amine oxide, most preferably an alkyldimethylamine oxide. Examples of such materials that find use in the composition are Ammonyx® LO from Stepan, Barlox® 12 from Lonza Corporation, and Surfox® LO Special from Surfactants, Inc. These compounds are essentially aqueous or water/alcohol solutions of lauryl- or myristyl-dimethylamine oxide or blends/chain length distributions thereof. The preferred level of nonionic surfactant to form a stable insecticide micro-emulsion is from about 0.1% to about 20% by weight of the composition and more preferably from about 1% to about 10%.

The Carboxylate

A “carboxylate” for purposes of this invention, refers to an organic molecule with at least one carboxylate group, which can be represented by the very general formula R—[CO₂M]ₓ, wherein R is any combination of alkyl, substituted alkyl or unsaturated alkyl group(s), or aryl or any substituted aryl group(s), and wherein x is at least 1, and M is hydrogen (the free carboxylic acid) or a cation (positively charged counter-ion) such as an alkali or transition metal, e.g. Na⁺, Li⁺, K⁺, Ca²⁺, Mg²⁺, Zn²⁺, and the like, in any combination, or ammonium or substituted ammonium cations such as NH₄⁺, R₄N⁺, R₃NH⁺, R₂H₂N⁺, RH₃N⁺, and the like, (where R=alkyl, substituted alkyl, aryl, or substituted aryl, or combinations thereof). Thus, it is important to recognize that for the purposes of formulating the insecticidal sprays of the present invention, the carboxylate material can be one or more mono-, di-, tri-, tetra- or polycarboxylic acids or their corresponding salts or partial salts either with single cations or mixed cations, and any combinations thereof. Also important to recognize is that salts of carboxylic acids may be directly added into the compositions of the present invention, or alternatively, free carboxylic acids may be added followed by either partial or full neutralization (pH adjustment/titration) with one or more alkaline species to generate the full, partial or mixed carboxylate salts in situ. The choice of either adding carboxylate salts or neutralizing the carboxylic acid(s) in situ may be made on the basis of cost, or ease of manufacturing, or in some cases to comply with EPA's current exempt product and inert ingredient lists under FIFRA (e.g., the salt of a carboxylic acid may be on the lists whereas the ingredients needed to make the carboxylate salt in situ, e.g. the free acid and the alkali, may not be on the current lists). Additionally, some mixed salts may not be readily available, so for example a free carboxylic acid may be added to the solution followed by sequential additions of two separate alkali sources (e.g., sodium hydroxide followed by ammonia NH₄OH) to make custom mixed salts of carboxylic acids in situ. As mentioned previously, the nature of the carboxylate material may have a profound effect on the efficacy of the spray toward ants. Thus it may be necessary to add combinations of carboxylic acids to achieve heightened efficacy. Most preferred is to add a single carboxylate material at from about 0.01% to about 15% by weight, or to add a buffer system comprising a mixture of salts and free carboxylates within the same family (e.g., monosodium citrate and trisodium citrate) at from about 0.1% to about 15% by weight to achieve a buffered pH target.

Carboxylate materials for use in the present invention may include mono-, di-, tri-, tetra-, and poly-carboxylates, for example with 1 (i.e., formic acid) to tens of thousands of carboxylate groups, (e.g., polyacrylates, and the like). Some useful carboxylates include, but are not limited to, the carboxylate salts (either mixed cations, single cations, either full or partially neutralized) of formic acid (methanoic acid)—HCOOH, acetic acid (ethanoic acid)—CH₃COOH, propionic acid (propanoic acid)—CH₃CH₂COOH, valeric acid (pentanoic acid)—C₄H₉COOH, enanthic acid (heptanoic acid)—C₆H₁₃COOH, pelargonic acid (nonanoic acid)—C₈H₁₇COOH, acrylic acid (2-propenoic acid)—CH₂═CHCOOH, sorbic acid (2-propenyl acrylic acid)—C₆H₈O₂ CH₃CH═CHCH═CHCOOH, fatty acids—medium to long chain saturated and unsaturated monocarboxylic acids, butyric acid (butanoic acid)—CH₃CH₂CH₂COOH, lauric acid (dodecanoic acid)—CH₃(CH₂)₁₀COOH, docosahexaenoic acid, eicosapentaenoic acid, pyruvic acid, acetoacetic acid, benzoic acid—C₆H₅COOH, salicylic acid, dicarboxylic acids such as aldaric acid, oxalic acid, malonic acid, malic acid, succinic acid, glutaric acid, adipic acid, the tricarboxylic acids such as citric acid, hydroxy acids such as lactic acid (2-hydroxypropanoic acid) and gluconic acid, tetra-carboxylate species such as ethylenediaminetetraacetic acid (EDTA), and the polymeric acids such as polyacrylic acid, and mixtures thereof. Preferred for use in the present compositions are the mono-, di-, tri-, and tetra-carboxylate species, most particularly citrate salts (notably Na⁺, Li⁺, K⁺, Ca²⁺, Mg²⁺, and/or Zn²⁺), lactate salts (notably Na⁺, Li⁺, K⁺, Ca²⁺, Mg²⁺, and/or Zn²), gluconate salts (notably Na⁺, Li⁺, K⁺, Ca²⁺, Mg²⁺, and/or Zn²⁺) or EDTA salts (noatably Na⁺, Li⁺, K⁺, Ca²⁺, Mg²⁺, and/or Zn²⁺). Most preferred are; monosodium citrate, disodium citrate, trisodium citrate (the latter being simply referred to sodium citrate); monopotassium citrate, dipotassium citrate, tripotassium citrate, calcium citrate (C₁₂H₁₀Ca₃O₁₄), magnesium citrate (C₁₂H₁₀Mg₃O₁₄), or zinc citrate (C₁₂H₁₀Zn₃O₁₄); sodium-, potassium-, calcium-, magnesium- or zinc lactate; sodium-, potassium-, calcium-, magnesium-, or zinc gluconate; sodium-, potassium-, calcium-, magnesium- or zinc sorbate; wherein all salts are either incorporated singly, or in combinations to produce various efficacy and stability. As mentioned, citric acid, lactic acid, gluconic acid or sorbic acid, or any free carboxylic acid, may be added directly to the composition followed by the suitable alkaline species in the requisic molar amounts to either form full or partial salts in situ. Ultimately the pH of the composition should be adjusted to be about 3.5 or greater and most preferred is to add one or more carboxylate salts such as monosodium, disodium and/or trisodium citrate at from about 0.01% to about 5% to achieve a pH of about 3.5 or greater and to optimize the efficacy against the target pests.

Fatty soaps may also be incorporated into the ant spray compositions as both an anionic surfactant component to assist in stabilizing the essential oil micro-emulsion and to aid in foaming and to assist with insecticidal efficacy as a “carboxylate” material. As used here, “fatty soap” means the salts of fatty acids although free fatty acid may be employed in the compositions of the present invention. For example, the fatty soaps that may be used here have general formula R—CO₂M, wherein R represents a linear or branched alkyl or alkenyl group having between about 8 and 24 carbons and M represents either H (free fatty acid), an alkali metal such as sodium or potassium, or ammonium or alkyl- or dialkyl- or trialkyl-ammonium or alkanolammonium cation. That fatty acids that may be the feed stock to the fatty soaps may be obtained from natural fats and oils, such as those from animal fats and greases and/or from vegetable and seed oils, for example, tallow, hydrogenated tallow, whale oil, fish oil, grease, lard, coconut oil, palm oil, palm kernel oil, olive oil, peanut oil, corn oil, sesame oil, rice bran oil, cottonseed oil, babassu oil, soybean oil, castor oil, and mixtures thereof. Fatty acids can be synthetically prepared, for example, by the oxidation of petroleum, or by hydrogenation of carbon monoxide by the Fischer-Tropsch process. The fatty acids may be linear or branched and containing from about 8 to about 24 carbon atoms, preferably from about 10 to about 20 carbon atoms and most preferably from about 14 to about 18 carbon atoms. Preferred fatty acids for use in the present invention are tallow or hydrogenated tallow fatty acids and their preferred salts (soaps) are alkali metal salts, such as sodium and potassium or mixtures thereof. Other useful soaps are ammonium and alkanol ammonium salts of fatty acids. The fatty acids that may be included in the present compositions will preferably be chosen to have desirable stabilizing effect on the essential oil micro-emulsion, effective foaming and substantial boosting of the insecticidal activity of the spray. The fatty acids may be incorporated as neutralized or partially neutralized soaps or as the free fatty acid, with or without subsequent neutralization in situ with various alkali sources.

Optional Solvent

Also useful in the present invention are one or more solvents. As mentioned, solvents may assist with formation of stable micro-emulsions and depending on the type, level and purity of the oil to emulsify into water, solvent may be required to assist the emulsifier(s) with micro-emulsion stability. Solvents may also be incorporated into the compositions to regulate the foam heights and foam stability of the compositions, (noting that solvents ordinarily have a foam reducing effect). Solvents that may be included in the present insecticide compositions include ethanol, isopropanol, n-propanol, n-butanol, MP-Diol (methylpropanediol), ethylene glycol, propylene glycol, and other small molecular weight alkanols, diols, and polyols, and ethers, and mixtures thereof, that may assist in emulsifying the essential oil into the water and stabilizing the emulsion when used at a level of from about 0.5% to about 5%. Satisfactory glycol ethers for use in the present ant spray compositions include ethylene glycol monobutyl ether (butyl cellosolve), diethylene glycol monobutyl ether (butyl carbitol), triethylene glycol monobutyl ether, mono, di, tri propylene glycol monobutyl ether, tetraethylene glycol monobutyl ether, mono, di, tripropylene glycol monomethyl ether, propylene glycol monomethyl ether, ethylene glycol monohexyl ether, diethylene glycol monohexyl ether, propylene glycol tertiary butyl ether, ethylene glycol monoethyl ether, ethylene glycol monomethyl ether, ethylene glycol monopropyl ether, ethylene glycol monopentyl ether, diethylene glycol monomethyl ether, diethylene glycol monoethyl ether, diethylene glycol monopropyl ether, diethylene glycol monopentyl ether, triethylene glycol monomethyl ether, triethylene glycol monoethyl ether, triethylene glycol monopropyl ether, triethylene glycol monopentyl ether, triethylene glycol monohexyl ether, mono, di, tripropylene glycol monoethyl ether, mono, di tripropylene glycol monopropyl ether, mono, di, tripropylene glycol monopentyl ether, mono, di, tripropylene glycol monohexyl ether, mono, di, tributylene glycol mono methyl ether, mono, di, tributylene glycol monoethyl ether, mono, di, tributylene glycol monopropyl ether, mono, di, tributylene glycol monobutyl ether, mono, di, tributylene glycol monopentyl ether and mono, di, tributylene glycol monohexyl ether, ethylene glycol monoacetate and dipropylene glycol propionate. When these glycol type solvents may be incorporated at a level of from about 0.5 to about 10%, and more preferably about 0.5% to about 5%. While all of the aforementioned glycol ether compounds assist with stability, the most preferred include diethylene glycol monobutyl ether and diethylene glycol monomethyl ether. Other suitable water-soluble co-solvents are water soluble esters such as ethyl lactate and water soluble carbohydrates such as butyl glycosides. The most preferred solvents for the present invention include ethanol, isopropanol, MP-Diol, diethylene glycol monobutyl ether and diethylene glycol monomethyl ether and mixtures thereof, with the preferred levels of from about 0.5% to about 5% by weight in the composition.

Dyes and Pigments

The compositions of the present invention may also include fragrances or masking agents or fragrance accords that negate or make more pleasant the scent naturally present due to the use of an essential oil. For example, the strong scent of clove oil may be counteracted by the judicial choice of fragrance accords that lessen the human perception of the odor of the essential oil. Additionally, the compositions of the present invention may include various dyes, pigments or other colorants to make the mixture more attractive to the consumer, or to make it safer (i.e., not to look edible), or to make it strongly colored enough to “mark” where it has been applied. For example, a strong colorant such as a pigment may be added such that the resulting foam applied to an ant trail takes on a bright color (e.g., red, green, blue).

Additional Ingredients as Synergists

Synergists are known to boost the efficacy of non-hazardous pesticides that are based on essential oil emulsions. A small amount of additional essential oil or a synthesized single component that is normally found in a complex essential oil mixture may be added as a synergist. These materials are preferably incorporated into the compositions, either singly or in combination, at from about 0.1% to about 15% by weight of the composition.

The synergists that may find use in the compositions of the present invention include, but are not limited to: Acetaldehyde, Acetaldehyde Diethyl Acetal, Acetaldehyde Natural, Acetic Acid Natural, Acetoin (Acetyl Methyl Carbinol), Acetoin Natural (Acetyl Methyl Carbinol), Acetophenone, Acetyl Butyryl, Acetyl Isovaleryl, Acetyl Propionyl, Acetyl Valeryl, miscellaneous straight chain C₈-C₁₈ aldehydes, Allyl Caproate, Allyl Heptoate, Allyl Phenoxyacetate, Almond Bitter Synthetic (Benzaldehyde), Amyl Acetate, Amyl Alcohol, Amyl Butyrate, Amyl Cinnamic Aldehyde, Amyl Cinnamic Aldehyde Natural, Amyl Iso Valerate, Amyl Propionate, Amyl Salicylate, Anethole, Anethole Natural, Anisaldehyde, Anisic Aldehyde, Anisic Aldehyde Natural, Anisyl Acetate, Anisyl Alcohol, Benzodihydropyrone (Dihydrocoumarin), Benzoin, Benzophenone, Benzyl Acetate, Benzyl Acetate Natural, Benzyl Alcohol, Benzyl Alcohol Natural, Benzyl Benzoate USP, Benzyl Butyrate, Benzyl Cinnamate, Benzyl Iso Butyrate, Benzyl Iso Valerate, Benzyl Phenyl Acetate, Benzyl Propionate, Benzyl Salicylate, Borneol, Bornyl Acetate, Laevo Bromelia (Nerolin) (Beta Naphtol Ethyl Ether), Butyl Acetate, Butyl Butyrate, Butyl Butyryl Lactate, Butyl Cyclohexanol, p-tert-Butyl Cyclohexyl Acetate, o-tert-Butyl Cyclohexyl Acetate, p-tert-Butylidene Phthalide, Butyric Acid, Camphor Powder Synthetic, Capric Acid, Caproic Acid, Caprylic Acid, Carvacrol, Carvacryl Ethyl Ether, d-, l-, or d,l-Carveol, Carvyl Acetate, Carvyl Propionate, beta-Caryophyllene, Cassis, Cedrenol, Cedrol, Cedryl Methyl Ether, Cedryl Acetate, Cinnamic Acid Natural, Cinnamic Alcohol, Cinnamic Aldehyde, Cinnamyl Acetate, Cinnamyl Iso Butyrate, Cinnamyl Propionate, Citral Natural, Citral Synthetic, Citronellal Natural, Citronellic Acid, Citronellol, Citronellyl Acetate, Citronelly Formate, Citronellyl Nitrile, Citronellyl Oxyacetaldehyde, Coumarin, Crotonic Acid, Cyclamen Aldehyde, Cyclohexyl Acetate, p-Cymene, trans, trans-2,4-Decadienal, Decanal, Decanoic Acid, trnas-2-Decenal, Delta Decalactone, Delta Dodecalactone, Diacetin (Glyceryl Diacetate), Diacetyl, Diethyl Phthalate, Diethyl Sebacate, Dihydroanethole, Dihydrocarveol, Dihydrocarvone, Dihydrocarvyl Acetate, Dihydrocoumarin (Benzodihydropyrone), Dihydromyrcenol, Dihydronoontkatone, Dimethyl Anthranilate, Dimethyl Phthalate, Dimethyl Sulfide, Dioctyl Adipate, Dioctyl Terephthalate, Diphenyl Oxide, Dipropylene Glycol, D-, L- or D,L-Limonene, trans-trans-2,4-Dodecadienal, trans-2-Dodecenal, Estragole, Ethyl 2-Methylbutyrate, Ethyl 2-Methyl-4-Pentenoate, Ethyl 3-Hydroxybutyrate, Ethyl Acetate, Ethyl Acetate, Ethyl Aceto Acetate, Ethyl Amyl Ketone, Ethyl methyl thiopropionate, Ethyl Benzoate, Ethyl Butyrate, Ethyl Caproate, Ethyl Caprylate, Ethyl Cinnamate, Ethyl Cinnamate, Ethyl Decanoate, Ethyl Formate, Ethyl Heptylate, Ethyl 2-Hexanol, Ethyl Hexyl, Ethyl Iso Valerate, Ethyl Lactate, Ethyl Laurate, Ethyl Levulinate, Ethyl Linoleate, Ethyl Maltol, Ethyl Myristate, Ethyl Pelargonate, Ethyl Phenyl Acetate, Ethyl Propionate, Ethyl Propionate, Ethyl Valerate, Ethyl Vanillin, Ethylene Brassylate, Ethyl-trans-2-cis-4-Decadienoate, Eucalyptol, Eugenol Methyl Ether, Eugenol, Eugenyl Acetate, Fenchone, Fenchyl Acetate, Fenchyl Alcohol, Formic Acid, Gamma Decalactone, Gamma Dodecalactone, Gamma Nonalactone (Aldehyde C-18), Gamma Octalactone, Gamma Undecalactone (Aldehyde C-14), Geranic Acid, Geraniol, Geranyl Acetate, Geranyl Formate, Geranyl Propionate, Geranyl Tiglate, Geranyl Undecylenate, Guaiol Acetate, Heliotropin, trans, trans-2,4-Heptadienal, 2,3-Heptanedione, Heptanol, 3,4-Hexandione, 2,3-Hexanedione, Hexanoic Acid, trans-2-Hexenal, trans-2-Hexenylacetate, Hexyl Acetate, Hexyl Alcohol, Hexyl Butyrate, Hexyl Caproate, alpha-Hexyl Cinnamic Aldehyde, para-Hydroxy Phenylbutanone, Hydroxycitronellal, iso-Amyl Acetate, iso-Amyl Alcohol, iso-Amyl Butyrate, iso-Amyl Caproate, iso-Amyl Caprylate, iso-Amyl Cinnamate, iso-Amyl Formate, iso-Amyl Hexanoate, iso-Amyl Butyrate, iso-Amyl Valerate, iso-Amyl Phenyl Acetate, iso-Amyl Propionate, iso-Amyl Salicylate, iso-Borneol, iso-Bornyl Acetate, iso-Bornyl Propionate, iso-Butyl Acetate Natural, iso-Butyl Alcohol, iso-Butyl Benzoate, iso-Butyl Butyrate, iso-Butyl Caproate, iso-Butyl Valerate, iso-Butyl Phenyl Acetate, iso-Butyl Propionate, iso-Butyraldehyde, iso-Butyric Acid, iso-Butyric Acid, iso-Eugenol, iso-Eugenyl Acetate, iso-Jasmone, iso-Menthone, iso-Nony Acetate, iso-Pulegol, iso-Safro Eugenol (Propenyl Guaethol), iso-Valeraldehyde, Iso-Valeric Acid, Lactic Acid, Lauric Acid, Lauric Aldehyde, Leaf Alcohol (cis-3-Hexenol), Lemongrass Terpenes, Lily Aldehyde, Limonene, Laevo, Linalool, Linalyl Acetate, Linalyl Butyrate, Linalyl iso-Butyrate, Linalyl Propionate, Maltol, Maple Lactone (Methyl cyclopentenolone), Mentha Arvensis (Cornmint), Mentha Piperita (Peppermint), Menthol, Menthone, o-Methoxy Cinnamaldehyde, Methoxy Phenyl Butanone, p-Methoxy benzaldehyde, Methyl 2-Methylbutyrate, Methyl Acetate, p-Methyl acetophenone, Methyl Anthranilate, Methyl Atratate, Methyl beta-Methyl thiopropionate, Methyl Benzoate, Methyl Butyrate, Methyl Caproate, Methyl Cedryl Ketone, Methyl Chavicol, Methyl Cinnamate, o-Methyl Cinnamaldehyde, Methyl Cyclopentenolone (Maple Lactone), Methyl Eugenol, Methyl heptyl ketone, Methyl iso-eugenol, Methyl Linoleate, Methyl Nonyl Ketone, Methyl Salicylate, Methyl Sulfide, p-Methyl phenoxy Acetaldehyde, Musk Ambreete, Musk Ketone, Musk Xylol, Myristic Acid, Neohesperidin Dihydrochalcone, Nerolin Bromelia, trans, trans-2,4-Nonadienal, cis-6-Nonenal, trans-2-Nonenal, cis-2-Nonenol, Nootkatone, Nonyl Acetate, trans, trans-2,4-Octadienal, Octanoic Acid, 3-Octanol, trans-2-Octenal, Octyl Acetate, Octyl Butyrate, Oleic Acid, 2,3-Pentanedione, Phellandrene, Phenoxy Acetaldehyde, Phenoxy Ethyl Propionate, Phenyl Ethyl Acetate, Phenyl Ethyl Alcohol, Phenyl Ethyl Cinnamate, Phenyl Ethyl iso-Butyrate, Phenyl Ethyl iso-Valerate, Phenyl Ethyl Methyl Ether, Phenyl Ethyl Phenyl Acetate, Phenyl Ethyl Propionate, Phenyl Ethyl Salicylate, Phenyl Propyl Alcohol, Phenyl acetaldehyde Diisobutylacetal, Phenylacetaldehyde dimethylacetal, Pinene, Propenyl Guaethol, Propionaldehyde, Propionic Acid, Propyl Acetate, Propyl Alcohol, Propyl Butyrate, Propyl Caproate, Propyl Hexanoate, Propylene Glycol, Pyruvic Acid, Rose Crystals (Trichloro methyl phenylcarbinyl acetate), Rose Oxide, Rum Ether, Safrole, Salicylaldehyde, Sinensal Natural, Styrallyl Propionate, Succinic Acid, Tannic Acid, Tartaric Acid, Terpineol, Terpinyl Acetate, Tetrahydrocarvone, Thymol Crystals, Tiglic Acid, Tolu Balsam Gum, o-Toluenethiol, Trichloro Methyl Phenyl Carbinyl Acetate, Triacetin, Trivertal, trans, trans-2,4-Undecadienal, delta- and gamma-Undecalactone, Undecylenic Aldehyde, Valencene, Valeraldehyde, Vanillin, Vanillin Isobutyrate, Vanitrope, Veratraldehyde, Vetiverol, Vetiveryl Acetate, and Yara Yara (Beta Naphtyl Methyl Ether).

Preferred synergists include 2-heptanone, CH₃(CH₂)₄COCH₃, acetone, CH₃COCH₃, 2-butanone, CH₃CH₂COCH₃, 2-pentanone, CH₃(CH₂)₂COCH₃, 2-hexanone, CH₃(CH₂)₃COCH₃, 2-octanone, CH₃(CH₂)₅COCH₃, 3-heptanone, CH₃(CH₂)₃COCH₂CH₃, 4-heptanone, CH₃(CH₂)₂CO(CH₂)₂CH₃, 1-heptanol, CH₃(CH₂)₅CH₂OH, ethyl butyrate, CH₃CH₂CH₂COCH₂CH₃, benzaldehyde, C₇H₆O, heptaldehyde, CH₃(CH₂)₅CHO, amyl cinnamic aldehyde, amyl salicylate, anisic aldehyde, benzyl alcohol, benzyl acetate, cinnamaldehyde, cinnamic alcohol, carvacrol, carveol, citral, citronellal, citronellol, p-cymene, diethyl phthalate, dimethyl salicylate, eucalyptol (cineole), iso-eugenol, galaxolide, guaiacol, ionone, menthol, methyl anthranilate, methyl ionone, methyl salicylate, α-phellandrene, pennyroyal oil, perillaldehyde, 1- or 2-phenyl ethyl alcohol, 1- or 2-phenyl ethyl propionate, piperonal, piperonyl acetate, piperonyl alcohol, D-pulegone, terpinen-4-ol, terpinyl acetate, 4-tert butyl cyclohexyl acetate, thymol, vanillin, ethyl vanillin, and mixtures thereof. Preferred synergists may be incorporated into the ant spray of the present invention at from about 0.1% to about 15%. Most preferred is to use 1-phenyl ethyl propionate or 2-phenyl ethyl propionate at from about 0.1% to about 5%.

Surfactant and Polymeric Foam Boosters

The compositions of the present invention may include additional surfactants beyond the emulsifier used to stabilize the oil-in-water emulsion, for the purposes of boosting and stabilizing the foam. As mentioned above, the foaming characteristic of these compositions increase efficacy, possibly by entangling the ants within the foam and increasing their exposure to the composition. Thus, it may be advantageous to foam boost and foam stabilize these compositions much in the same way hand dishwashing liquids and agricultural “foam markers” are formulated. In this way, foam boosters such as the nonionic amine oxide surfactants (e.g., under the trade name Barlox® from Lonza) and/or fatty acid alkanolamides (e.g., under the trade name Ninol® from Stepan) may be used to boost and stabilize the foam. Polymers such as xanthan gums and other polysaccharide materials may also be used to stabilize the foam. Lastly, it may be advantageous to “control” the foam by addition of materials (e.g. alcohol solvents) to help break the foam if it appears that it will remain too long on a surface. For example, it may be advantageous to fine tune the foam height and length of life of the foam such that the foam holds long enough to entangle the ants and kill them, but then breaks to leave behind the dead ants in a liquid that is easy to wipe up or flush away. Foam boosting surfactants and/or polysaccharide polymers may be added at from about 0.01% to about 2% by weight in the composition.

Preservatives

Although many of the compositions of the present invention appear to be self-preserving against mold and bacteria growth, conventional preservatives may be added to the compositions to improve shelf life. Useful preservatives are available from Rohm and Haas under the trade name of Kathon®, and even simple food preservatives such as potassium sorbate has been found effective to preserve formulas that are only weakly self-preserving. For example, potassium sorbate may be added at from about 0.01% to about 0.5% by weight.

Optional Electrolytes

The compositions of the present invention may also include various electrolytes to aid efficacy, stability, or to render visible improvements to the formula (e.g. add viscosity or effect foam height/stability). Electrolytes that may find use here include the common chloride salts such as sodium, potassium, lithium, magnesium, calcium, zinc chloride and the like, and the sulfates such as sodium, magnesium or potassium sulfate. For example the use of sodium chloride in a composition containing sodium lauryl sulfate is an economically way to impart a small amount of viscosity, for example enough viscosity to control dripping from the end of a trigger sprayer.

Packaging and Dispensing

The liquid composition such as represented by these particular embodiments may be placed in a glass or plastic bottle equipped with a trigger sprayer and simply sprayed onto the ants, mounds or trails, or more preferably, the liquid may be aerosolized along with a propellant (e.g., hydrocarbon, CO₂, compressed air and the like) in an aerosol package (can and crimped valve) and dispensed through actuation of an aerosol valve to produce a foam that entangles the ants, increases the exposure of the ants to the composition and heightens the efficacy. Most preferably, a non-aerosol “foaming trigger” sprayer may be used to dispense the compositions of the present invention, (i.e., incorporating a screen or other members in the trigger sprayer that entrain air). In this way foam may be applied directly onto the ants, mounds, or trails via a non-aerosol method. Not being bound by any theory, it appears that foamed delivery of the compositions of the present invention (either aerosol or non-aerosol foaming trigger-sprayer delivery) have heightened kill to ants because the ants become somewhat immobilized and/or entangled within the cells of the foam and that brief immobilization increases the exposure of the ants to the insecticidal essential oil composition causing higher mortality rates.

Formulations and Efficacy Data

Table 1 lists specific embodiments of the ant spray of the present invention, along with corresponding pH and efficacy data. For the efficacy testing, Argentine ants, Linepithema humile (Mayr) were used. The testing protocols were in-house adaptations of published methods; EPA Product Performance Test Guidelines OPPTS 810.1000, OPPTS 810.3000, and OPPTS 810.3500; and, ASTM E654-96 (2003) entitled “Standard Test Method for Effectiveness of Aerosol and Pressurized Spray Insecticides against Cockroaches”. The in-house method includes wiping the ants with a paper towel following spraying. Ants are then observed to be dead or moribund on or off of the paper towel, or alive. Since all ants are on the paper towel after being wiped up, dead ants on the paper towel are categorized as having died instantly, whereas those dead off of the paper towel did not die instantly following the treatment.

Efficacy data is listed in Table 1 as both the “Percent % Instant Kill” and “Percent % Ants Alive” and each of these are listed as two numbers, in the former case as a “low” and a “24-hr” number, and in the latter case, as a “peak” and a “24-hr” number. This presentation of the data is necessary because ants that are knocked down may end up eventually dying or may end up detoxifying the insecticide to literally “come back to life”. In this way, “% Instant Kill” “low” refers to the minimum percentage of ants dead on the paper towel over the course of the 24-hr experiment. The “% Instant Kill” “24-hrs” refers to a “confirmation” of the percentage of ants that were dead on the paper towel at 24 hrs, when no further recovery is expected. On the other hand, the “% Ants Alive” “Peak” value refers to the maximum percentage of live ants observed over the course of the 24-hr experiment. The “% Ants Alive” “24-hrs” value refers simply to the percentage of ants truly alive at 24-hrs, when no further recovery from the treatment is expected. “N/A” refers to no efficacy testing for that formula due to stability problems with the mixture.

The “essential oil” ingredient listed in each column of Table 1 is identified through a code letter. In the table, the letter following the weight percentage of the essential oil corresponds to a particular organic material. The code letters used are as follows: “a” is lemongrass oil; “b” is citronella oil; “c” is eugenol; “d” is clove oil; “e” is thyme oil; “f” is geranium oil, Pelargonium graveolens, African sourced; “g” is geranium oil, Pelargonium graveolens, Egyptian sourced; “h” is geranium oil from Argeville, Maugins, France, 100% natural, CAS #90082-51-2; and, “i” is geranium oil Produkt F061 (4430) from Argeville, Maugins, France, CAS #8000-46-2, comprising Geranium Bourbon ESS, Pelargonium graveolens.

In looking at the embodiments in Table 1, it is evident that very efficacious compositions may be comprised of geranium oil (formulas 18 and 24 for example), eugenol (formula 14 for example), clove oil (formula 29) and thyme oil (formula 30) provided the carboxylate salt is chosen to optimize efficacy. Additionally, the synergist 2-phenyl ethyl propionate is shown to greatly improve efficacy of a formula having reduced levels of geranium oil (comparing formula 28 to 27 for example).

It has thus been shown that highly efficacious insecticidal products are possible through compositions comprising an essential oil, an emulsifier, a carboxylate and water. Most evident is that compositions comprising monosodium or trisodium citrate are particularly potent and allow for reduced amounts of expensive essential oil. Lastly, the synergist 2-phenyl ethyl propionate has been shown to greatly increase a geranium oil formulation, allowing for very low levels of essential oil.

TABLE 1
Examples of Useful Foaming Ant Spray Compositions

| Ingredient/ | Formula Number/Weight Percent ingredients | | | | | | | | | | | | | | |
|---|---|---|---|---|---|---|---|---|---|---|---|---|---|---|---|
| pH/Efficacy | 1 | 2 | 3 | 4 | 5 | 6 | 7 | 8 | 9 | 10 | 11 | 12 | 13 | 14 | 15 |
| Essential Oil | 0.10a | 0.10f | 0.10b | 0.20f | 0.40f | 0.20f | 0.50f | 0.20f | 0.50f | 0.50b | 0.20b | 0.50c | 0.20c | 1.00c | 0.50c |
| Citric Acid— | 0.05 | 0.05 | 0.05 | — | — | — | — | 15.00 | 10.00 | — | — | — | — | — | — |
| C₆H₈O₇ | | | | | | | | | | | | | | | |
| Monosodium | — | — | — | — | — | — | — | — | — | — | — | — | — | — | — |
| Citrate— | | | | | | | | | | | | | | | |
| NaC₆H₇O₇ | | | | | | | | | | | | | | | |
| Trisodium | — | — | — | 2.50 | 2.50 | 1.50 | 0.50 | — | — | 2.00 | 2.00 | 2.00 | 2.00 | 1.50 | 2.00 |
| Citrate— | | | | | | | | | | | | | | | |
| Na₃C₆H₅O₇ | | | | | | | | | | | | | | | |
| Sodium Lauryl | 5.00 | 5.00 | 5.00 | 5.00 | 3.00 | 5.00 | 5.00 | 5.00 | 5.00 | 5.00 | 5.00 | 5.00 | 5.00 | 5.00 | 5.00 |
| Sulfate | | | | | | | | | | | | | | | |
| 2-Phenyl ethyl | — | — | — | — | — | — | — | — | — | — | — | —— | — | — | — |
| propionate— | | | | | | | | | | | | | | | |
| C₁₁H₁₄O₂ | | | | | | | | | | | | | | | |
| Water, dyes, | q.s. | q.s. | q.s. | q.s | q.s | q.s. | q.s. | q.s. | q.s. | q.s. | q.s. | q.s. | q.s. | q.s. | q.s. |
| preservative | | | | | | | | | | | | | | | |
| pH | 4.5 | 4.0 | 4.5 | 9.6 | 8.2 | 9.7 | 9.3 | 1.9 | 2.0 | 10.0 | 10.1 | 9.8 | 10.0 | 8.5 | 9.7 |
| % Instant Kill | N/A | N/A | N/A | N/A | N/A | 69-69 | 68-74 | 42-55 | 70-74 | 51-49 | 56-58 | 79-77 | 57-54 | 98-99 | 59-62 |
| (“low”— | | | | | | | | | | | | | | | |
| “24 hrs”) | | | | | | | | | | | | | | | |
| % Ants Alive | N/A | N/A | N/A | N/A | N/A | 23-0 | 21-0 | 23-0 | 12-4 | 30-7.5 | 28-0 | 13-0 | 34-10 | 0-0 | 25-0 |
| (“peak”— | | | | | | | | | | | | | | | |
| “24 hrs”) | | | | | | | | | | | | | | | |

| Ingredient/ | Formula Number/Weight Percent ingredients | | | | | | | |
|---|---|---|---|---|---|---|---|---|
| pH/Efficacy | 16 | 17 | 18 | 19 | 20 | 21 | 22 | 23 |
| Essential Oil | 2.00f | 1.50f | 2.00f | 1.50f | 0.50f | 0.50g | 0.50g | 1.50g |
| Citric Acid—C₆H₈O₇ | — | — | — | — | — | — | — | — |
| Monosodium Citrate— | — | — | — | — | — | — | 2.00 | — |
| NaC₆H₇O₇ | | | | | | | | |
| Trisodium Citrate— | — | — | 3.00 | 2.00 | — | 2.00 | — | 2.00 |
| Na₃C₆H₅O₇ | | | | | | | | |
| Sodium Lauryl Sulfate | 10.00 | 10.00 | 5.00 | 5.00 | 15.00 | 15.00 | 15.00 | 5.00 |
| 2-Phenyl ethyl propionate— | — | — | — | — | — | — | — | — |
| C₁₁H₁₄O₂ | | | | | | | | |
| Water, dyes, preservative | q.s. | q.s. | q.s. | q.s. | q.s | q.s | q.s. | q.s. |
| pH | 8.9 | 8.6 | 7.6 | 7.7 | 10.1 | 9.8 | 4.0 | 7.8 |
| % Instant Kill (low—24 hrs) | 95-100 | 58-72 | 98-98 | 98-98 | 90-95 | 85-98 | 75-75 | 90-92 |
| % Ants alive (peak 24 hrs) | 0-0 | 11-0 | 0-0 | 2.5-0 | 0-0 | 2-0 | 2-0 | 0-0 |

| Ingredient/ | Formula Number/Weight Percent ingredients | | | | | | |
|---|---|---|---|---|---|---|---|
| pH/Efficacy | 24 | 25 | 26 | 27 | 28 | 29 | 30 |
| Essential Oil | 1.50g | 1.50i | 1.50h | 1.00h | 0.25i | 1.50d | 1.50e |
| Citric Acid—C₆H₈O₇ | — | — | — | — | — | — | — |
| Monosodium Citrate— | 2.00 | 2.00 | 2.00 | 2.00 | 2.00 | 0.50 | 0.50 |
| NaC₆H₇O₇ | | | | | | | |
| Trisodium Citrate— | — | — | — | — | — | — | — |
| Na₃C₆H₅O₇ | | | | | | | |
| Sodium Lauryl Sulfate | 5.00 | 5.00 | 5.00 | 5.00 | 7.50 | 5.00 | 5.00 |
| 2-Phenyl ethyl propionate— | — | — | — | — | 1.25 | — | — |
| C₁₁H₁₄O₂ | | | | | | | |
| Water, dyes, preservative | q.s. | q.s. | q.s. | q.s. | q.s. | q.s. | q.s. |
| pH | 3.7 | 3.8 | 3.9 | 3.9 | 4.4 | 4.9 | 4.9 |
| % Instant Kill (low—24 hrs) | 100-100 | 58-58 | 55-60 | 29-35 | 95-98 | 92-95 | 86-97 |
| % Ants alive (peak 24 hrs) | 0-0 | 16-7 | 31-18 | 42-4 | 2.5-0 | 2-0 | 3-0 |

a= lemongrass oil;
b= citronella oil;
c= eugenol;
d= clove oil;
e= thyme oil;
f= geranium oil, Pelargonium graveolens, African;
g= geranium oil, Pelargonium graveolens, Egyptian,
h= geranium oil from Argeville, Maugins, France, 100% natural, CAS# 90082-51-2; and,
i= geranium oil, Produkt F061 (4430) from Argeville, Maugins, France, CAS# 8000-46-2, Geranium Bourbon ESS, Pelargonium graveolens.

1-9. (canceled)

10. A method for killing and controlling ants, said method comprising the steps of:
a. providing a foaming composition within a container equipped with a foaming sprayer, said foaming composition comprising (i) an essential oil; (ii) an emulsifier selected from the group consisting of alkyl sulfates, alkyl ether sulfates, alkyl sulfonates, aryl sulfonates, alcohol ethoxylates, and mixtures thereof; (iii) a carboxylate salt; and (iv) water;
b. foaming said composition directly onto ants, ant mounds or ant trails; and,
c. allowing sufficient time for the ants to perish within the generated foam.

11. The method of claim 10, wherein said essential oil consists essentially of geranium oil derived from either Pelargonium graveolens or Pelargonium odorantissimum plant species, or both.

12. The method of claim 11, wherein said carboxylate salt is present at from 0.01% to 5% by weight and is selected from the group consisting of monosodium citrate, disodium citrate, trisodium citrate, and mixtures thereof.

13. The method of claim 12, wherein said composition has a pH of about 3.5 or greater.
